(19) United States
(12) Patent Application Publication
(10) Pub. No.: US 2026/0055607 A1
(43) Pub. Date: Feb. 26, 2026

(54) LIGHTWEIGHT COMPOSITE BUILDING PANELS WITH INCORPORATED DRAINAGE LAYER FOR MOISTURE REMOVAL

(71) Applicant: HYDROBLOK, INC., Park City, UT (US)

(72) Inventors: Zhongsheng CHEN, Draper, UT (US); Brian DUNN, Draper, UT (US); Alex GILLESPIE, Draper, UT (US)

(21) Appl. No.: 19/306,826

(22) Filed: Aug. 21, 2025

Related U.S. Application Data
(60) Provisional application No. 63/686,489, filed on Aug. 23, 2024.
(60) Provisional application No. 63/692,563, filed on Sep. 9, 2024.
(60) Provisional application No. 63/720,649, filed on Nov. 14, 2024.
(60) Provisional application No. 63/729,637, filed on Dec. 9, 2024.

(51) Int. Cl. E04C 2/288; B32B 3/30; B32B 5/18; B32B 13/04; B32B 13/12; C04B 14/30; C04B 28/18; C04B 103/30; C04B 103/50; C04B 111/00; C08J 9/36; C09D 175/02; C09D 177/04; E04C 2/00; E04C 2/52

(52) U.S. Cl. CPC E04C 2/288; B32B 3/30; B32B 5/18; B32B 13/045; B32B 13/12; C04B 14/308; C04B 28/18; C08J 9/365; C09D 175/02; C09D 177/04; E04C 2/526; B32B 2260/021; B32B 2260/044; B32B 2260/046; B32B 2266/0214; B32B 2307/7376; B32B 2607/00; C04B 2103/302; C04B 2103/50; C04B 2111/00612; E04C 2002/007; E04C 2002/008

(57) ABSTRACT

Lightweight composite building panels with incorporated drainage layer that facilitates moisture removal and methods of manufacturing and using lightweight composite building panels with incorporated drainage layer. The lightweight composite building panels with incorporated drainage layer can be used to applied a desired finish to exterior wall and roof structures. The lightweight composite building panels include a core composite panel structure and a drainage layer attached or bonded thereto. The core composite panel structure includes a foam core sandwiched between first and second protective layers, such as a fiber mesh reinforced cementitious composition and/or cured thermoset resin or other rigid material. The drainage layer is designed to face an exterior wall or roof structure to facilitate removal of moisture between the panels and underlying wall or roof structure. The building panels can be cut, drilled, and screwed, nailed, or glued to structural elements of buildings, such as OSB sheathing.

### CROSS-REFERENCE TO RELATED APPLICATIONS

This application claims the benefit of U.S. Provisional Application No. 63/729,637, filed Dec. 9, 2024, U.S. Provisional Application No. 63/720,649, filed Nov. 14, 2024, U.S. Provisional Application No. 63/692,563, filed Sep. 9, 2024, and U.S. Provisional Application No. 63/686,489, filed Aug. 23, 2024, which are incorporated by reference in their entirety.

### BACKGROUND

### Technical Field

This disclosure relates to lightweight composite building panels with an incorporated drainage layer for moisture removal and methods for making and using lightweight composite building panels with incorporated drainage layer.

### Related Technology

Houses and other buildings are typically constructed using wood or metal studs to form a three-dimensional wall frame, which can include an interior wall on one side and an exterior wall on the other. Alternatively, both sides can be interior walls, such as interior walls separating rooms or walls dividing attached dwelling units such as apartments, town houses, and condominiums. In some cases, both sides can be exterior walls, such as fences, screen walls, sound barriers, walls that partially enclose carports, dumpster surrounds, and the like.

Interior walls of houses and other buildings are typically formed using drywall (e.g., gypsum board) to form a generally flat underlying wall surface, which can be painted, wallpapered, or treated with other desired finishes. A drywall panel typically consists of a layer of gypsum plaster sandwiched between two layers of paper. While suitable for walls which are not exposed to water, drywall is not suitable for applications exposed to water and high humidity environments. Drywall is highly vulnerable to moisture due to the inherent properties of the materials that constitute it: gypsum, paper, and organic additives and binders. Gypsum will soften with exposure to moisture and turn into a goocy paste with prolonged immersion, such as during a flood or even in a bathroom when exposed to excessive water. For applications where walls will be exposed to moisture, such as in bathrooms, particularly showers and bathtubs, cement board is typically used. A major disadvantage of cement board is its relative high density (e.g., weight per square foot). Cement board weighs approximately twice as much as gypsum board, making handling by one person difficult.

Exterior walls and wall finishes have their own unique challenges. In general, exterior walls are typically formed by fastening sheathing, typically wooden boards, to form exterior walls, followed by the application of a waterproof membrane, followed by the application of one or more surface finishes, most of which require several steps and layers. The wooden sheathing boards can be any kind of plywood. The currently preferred and most common wooden sheeting used to make exterior walls are oriented strand board (“OSB”) panels because of their favorable cost and combination of materials properties. OSB units are typically used to form outer walls to which desired finishing elements can be attached, such as stucco, bricks, stone, panels, fixtures, and the like.

OSB panels are not waterproof but prone to swelling, rotting, and developing mold and mildew if exposed to water over time. They are typically wrapped with a waterproof polymer membrane to keep external water from contacting the OSB panels. The waterproof polymer membrane can also provide an air barrier that prevents unwanted air leakage. In addition, flashing, tape, and sealants can be used around joints to prevent water and air intrusion. Thereafter, one or more layers of other materials are applied over the polymer membrane to form a finished outer wall.

Examples of finishes that can be applied over exterior wall and roof sheathing include, but are not limited to, stucco, thin bricks, natural and manufactured stone veneers, tiles, shingles, metal cladding, and the like. In addition to applying an appropriate water-resistive barrier (WRB), application of finishes typically requires means for attaching them to sheathing or other structural elements of a wall or roof structure.

Stucco is a common finish applied to exterior walls of houses, apartments, town houses, condominium, and other buildings. There are two main stucco systems, traditional stucco systems and exterior insulation and finish systems (EIFS). Both require the application of multiple layers of different materials that are heavy, time consuming, labor intensive, and in some cases bulky, hard to manipulate and apply, and potentially dangerous (e.g., when standing on scaffolding).

In a traditional stucco system applied to a building with exterior sheathing comprising wooden boards (e.g., OSB panels), the sheathing is wrapped with one or more layers (e.g., polymer membrane and/or a black paper layer) to provide protection against moisture. Next, lath, which is typically some type of wire mesh, is installed over the one or more outer protective layers, typically using staples and/or nails. A scratch coat made from sand, cement, water, and optional components is applied over the lath using a trowel or sprayer, followed by forming rough horizontal ridges and troughs using a scarifier tool while the scratch coat is still in a plastic state. A brown coat made from sand, cement, water, and optional components is applied over the scratch coat to provide a smooth surface to which the stucco finish is applied. The scratch coat provides both mechanical and chemical bonding of the brown coat. Finally, a stucco finish is applied over the brown coat. Cement-based stucco is typically applied directly to the brown coat. If acrylic stucco is the final finish, a primer can be applied to the brown coat to improve adhesion and prevent delamination of the acrylic stucco finish.

In an EIFS stucco system, a building with exterior sheathing comprising wooden boards (e.g., OSB panels) is coated with a liquid moisture barrier material, which hardens into a solid moisture barrier layer. A primer is applied over the moisture barrier layer, and a rain screen, e.g., an adhesive layer with spaced apart notches or ridges that act vertical drainage channels is applied to the primer. An insulating foam layer is placed over the adhesive layer, which bonds the foam layer to the wall. A base coat with embedded mesh is applied over the foam layer. The base coat can comprise thin set mortar, optionally with a primer (or a primer can be applied over the base coat). In some cases, as second base coat may be applied to fully embed and hide the mesh. Finally, a stucco finish is applied over the base coat. The stucco finish is typically acrylic stucco, which is why a primer may be required on or in the base coat. Alternatively, the stucco finish can be cement stucco

Accordingly, there remains a need for structural panels for exterior use that are waterproof, provide high strength, are lightweight to facilitate installation, are resistant to heat and combustion, and can provide a surface for attachment of desired finishes.

### SUMMARY

Disclosed are lightweight composite building panels with incorporated drainage layer that facilitates moisture removal and methods of manufacturing and using lightweight composite building panels with incorporated drainage layer. The lightweight composite building panels with incorporated drainage layer can be used in place of conventional building panels, including but not limited to exterior wall sheathing, underlayments, backer boards, soffits, roofing decks, and the like.

The lightweight composite building panels comprise a core composite panel structure and a drainage layer attached or bonded to a side of the core composite panel. The core composite panel structure comprises a lightweight foam core sandwiched between first and second protective layers, such as a fiber mesh reinforced cementitious composition and/or cured thermoset resin or other rigid material. The drainage layer can be applied over the side of the core composite panel structure that is intended to face an exterior wall or roof structure to facilitate removal of moisture between the panels and underlying wall or roof structure. The lightweight composite building panels can be cut, drilled, and screwed, nailed, or glued to structural elements of buildings, such as wall frames comprising wooden or metal studs, roof frames comprising boards, studs, or trusses, exterior sheathing (e.g., OSB panels), and the like.

In some embodiments, one or more protective layers of the core composite panel structure comprise a fiber mesh reinforced cementitious composition, and the drainage layer is typically a lightweight polymer material with passages for moisture removal. As a result, the lightweight composite building panels are strong and can support relatively heavy loads using nails, screws, and other fasteners known in the art. Protective layers made from fiber mesh reinforced cementitious composition can be “thin” (e.g., typically less than about 3 mm, less than about 2.5 mm, less than about 2 mm, or less than about 1.5 mm, such as about 1 mm, in cross-sectional thickness), are lightweight yet waterproof and have high structural strength (i.e., high tensile and flexural strength and high toughness). The fiber mesh component is typically fiberglass fiber or filament mesh but can be made of other strong fibers or filaments, such as carbon fibers or filaments.

In addition to, or instead of, a fiber mesh reinforced cementitious layer, one or both protective layers of the core composite panel structure may comprise other materials in addition to or instead of the cementitious composition. Examples include one or more of rigid magnesium oxide material, water-resistant polymer, or a composite material comprising a resin or polymer with embedded fibers, fiber mesh, fabric, woven, scrim, felt, or non-woven. The material forming the fibers, fiber mesh, fabric, scrim, felt, or non-woven can be selected from plant fibers, polymer fibers, and inorganic fibers (e.g., basalt, rock wool, and the like). The resin or polymer may comprise a thermoplastic or thermoset material, such as UV-cured resins, polypropylene, polycarbonate, polyethylene terephthalate, polystyrene, acrylate, methacrylate, polyurea, polyaspartic, or epoxy. Protective layers of thermoset polymer can be slightly thicker than fiber mesh reinforced cementitious layers, such as between about 1-5 mm or about 2-3 mm.

The lightweight foam core is typically made from extruded polystyrene foam (XPS) but can alternately comprise expanded polystyrene foam (EPS), polyisocyanurate foam, polyurethane (PUR) foam, phenolic polymers (e.g., phenol-formaldehyde) melamine polymers (e.g., melamine-formaldehyde), and/or other thermoplastic and thermoset polymers known in the art that can be formed into rigid or semi-rigid foam layers. Alternatively, the foam core may comprise an inorganic foam materials, such as a refractory foam material, to provide additional fire-resistance. Examples include silica gel, aerogel, silicate foams, urea-silicate foam, SiOC/SiC, ceramic foams, refractory foams, and the like. The inorganic foam core can resist melting even when exposed to fire or intense heat in order for the core composite panel structure to maintain its structural integrity.

In some embodiments, the core composite panel structure can be manufactured by applying a fiber (e.g., fiberglass) mesh and cementitious or curable resin composition onto front and back surfaces of a foam sheet, such as an XPS or other polymer foam core and causing or allowing the cementitious or curable resin composition to harden. The fiber mesh can be embedded in the cementitious or curable resin composition to enhance strength, increase toughness, and prevent cracking. In some embodiments, a fresh cementitious composition comprises mixture products of hydraulic cement, silicon dioxide powder, calcium oxide, iron oxide, plaster of Paris (gypsum hemihydrate), water-reducing agent, defoamer, styrene, and acrylic acid. The hydraulic cement typically includes Portland cement, but may also include supplementary cementitious materials (SCMs), such as ground granulated blast furnace slag (GGBFS), fly ash, natural pozzolan, silica fume, microsilica, metakaoline, ground glass, calcined clay, finely ground quartz, and the like. The fresh cementitious composition may include other components, such as natural hydraulic lime, calcium silicate, and/or expanded glass, which can increase fire and heat resistance.

The core composite panel structure can be modified to function as a lightweight composite building panel, such as when constructing exterior wall structures, that facilitates removal of moisture between the panels and underlying building structure. The core composite panel structure is modified by attaching a drainage layer (e.g., polymer uncoupling membrane, embossment, drainage plane, rain screen, dimple board, factory applied dimples or dots, or bleed layer (collectively “drainage layer”) to an interior surface that is designed to face a wall or roof structure. The drainage layer provides a built-in drainage plane by providing spaced contact points that create a capillary break, enabling vertical drainage of incidental moisture. The drainage layer provides gaps and channels between the core composite panel structure and the underlying wall or roof structure (e.g., studs, trusses, and/or OSB sheathing) to permit moisture to collect and drain and/or evaporate, thereby protecting outer surface finishes and preventing or minimizing formation of mold, mildew, and structural damage of the underlying wall or roof structure and/or exterior finish, such as by freeze-thaw cycles, delamination, or other water-related issues.

The drainage layer can be applied using to the core composite panel structure using waterproof adhesive or directly adhered to the cementitious composition or thermoset polymer used to make the protective layer on the interior side of the core composite panel structure. In some embodiments, the protective layer on the side of the core composite structure that is configured to be placed against sheathing or other structural elements may comprise a waterproof (e.g., polymer) material that is pre-formed or molded to include gaps and channels that can function as a drainage layer to facilitate moisture removal. In other embodiments, a built-in drainage plane can be formed by applying a field of raised adhesive dimples to the back surfaces of the lightweight composite building panel.

In some embodiments, the lightweight composite building panels have an exterior surface that facilitates direct attachment of a desired surface finish, such as stucco, thin bricks, natural and manufactured stone veneers, tiles, roofing shingles, wood shakes. metal cladding, and the like. For example, a desired finish can be adhered to an exterior fiber mesh reinforced cementitious layer. The lightweight composite building panels include the aforementioned drainage layer to facilitate removal of moisture between the lightweight composite building panels and the underlying wall or roof structure.

The lightweight composite building panels can be fastened to wall or roof structures of a building using mechanical fasteners and adhesives known in the art, such as wood screws, sheet metal screws, nails, rivets, and construction adhesive. Mechanical fasteners are advantageously corrosion resistant. Strips of tape can be used as a template to ensure proper placement of screws or other mechanical fasteners when fastening lightweight composite building panels to studs or other structural elements of wall or roof structures. To prevent screws from tearing through the exterior fiber mesh reinforced cementitious layer, screws can be used with enlarged washers having high surface area to distribute the pressure or load over a high surface area of the lightweight composite building panels. Specialized washers with penetrating prongs can be used (e.g., with screws) to limit rotation and penetration, preventing damage to the lightweight composite building panels. Rectangular washers with multiple prongs on either side of the screw can be used to tie adjacent lightweight composite building panels together. The penetrating prongs can have a length so that the washers lie flush with or just below the surface of the exterior fiber mesh reinforced cementitious layer. A patch coating can be applied over the washers to fill any indentations caused by the washers or other mechanical fasteners.

Additional features and advantages will be set forth in part in the description that follows, and in part will be obvious from the description, or may be learned by practice of the embodiments disclosed herein. It is to be understood that both the foregoing brief summary and the following detailed description are exemplary and not restrictive of the embodiments disclosed herein or as claimed

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIG. 1A is a side perspective view that illustrates examples of different sizes of core composite panel structures, which can be modified with a drainage layer to form lightweight composite building panels;

FIG. 1B is a top perspective view that illustrates the differently-sized core composite panel structures of FIG. 1;

FIG. 2 is an exploded diagram that schematically illustrates the layered structure of the core composite panel structures of FIGS. 1A and 1B;

FIGS. 3A and 3B illustrate examples of lightweight composite building panels for exterior use with an attached drainage layer with gaps or channels that facilitate removal of moisture from between the lightweight composite building panel and an exterior wall or roof structure to which it is attached;

FIGS. 4A-4D illustrate alternative embodiments of drainage layers, variously known as uncoupling membranes, drainage planes, rain screens, dimple boards, or bleed layers, with gaps or channels that can be attached to core composite panel structures to form lightweight composite building panels that facilitate removal of moisture from between the panels and an exterior wall or roof structure to which they are attached;

FIGS. 5A-5C illustrates outdoor systems for applying a desired cladding or exterior finish to an exterior wall of a building and means (e.g., an air gap and metal flashing) for permitting air flow and removal of moisture from spaces between the cladding or exterior finish and the exterior wall;

FIGS. 6A-6C illustrate an embodiment of a specialized fastener assembly comprising a screw and specialized enlarged washer with multiple prongs designed to penetrate at least partially through and become embedded within the lightweight composite building panels;

FIG. 7 illustrates a lightweight composite building panel with an applied stucco finish on the exterior fiber mesh reinforced cementitious layer;

FIG. 8 illustrates lightweight composite building panels attached to OSB sheathing using enlarged washers; and

FIG. 9 illustrates an exterior wall made using lightweight composite building panels with various applied exterior finishes, including stucco, stone, and tiles applied over exterior fiber mesh reinforced cementitious layers.

### DETAILED DESCRIPTION

### I. Overview

Disclosed herein are lightweight composite building panels that are strong, lightweight, moisture and heat resistant, and include a drainage layer that facilitates removal of moisture between the building panels and sheathing or other structural elements to which they are attached. Also disclosed are compositions and methods for manufacturing lightweight composite building panels with incorporate drainage layer. The lightweight composite building panels can be used in place of conventional building panels including, but not limited to, exterior wall sheathing, underlayments, backer boards, soffits, roofing decks, and the like. The lightweight composite building panels can have an exterior surface that facilitates direct attachment thereto of a desired surface finish, such as stucco, thin bricks, natural and manufactured stone veneers, tiles, roofing shingles, wood shakes. metal cladding, and the like.

The lightweight composite building panels comprise a core composite panel structure and a drainage layer incorporated onto a side of the core composite panel. The core composite panel structure comprises a lightweight foam core sandwiched between first and second protective layers, such as a fiber mesh reinforced cementitious composition and/or cured thermoset resin or other rigid material. The drainage layer can be applied (e.g., attached, adhered, or fastened) to a side of the core composite panel structure that is intended to face an exterior wall or roof frame (e.g., to facilitate removal of moisture from between the lightweight composite building panels and the exterior wall or roof structure). In some embodiments, the protective layer on the side of the core composite structure that is configured to be placed against sheathing or other structural elements may comprise a waterproof (e.g., polymer) material that is pre-formed or molded to include gaps and channels that can function as a drainage layer to facilitate moisture removal

The lightweight composite building panels can be cut, drilled, and screwed, nailed, or glued to structural elements of buildings, such as wall frames comprising wooden or metal studs, roof frames comprising boards, studs, or trusses, exterior sheathing (e.g., OSB panels), and the like. Specialized washers with penetrating prongs can be used (e.g., with screws) to limit rotation and penetration, preventing damage to the lightweight composite building panels.

### II. Core Composite Panel Structure

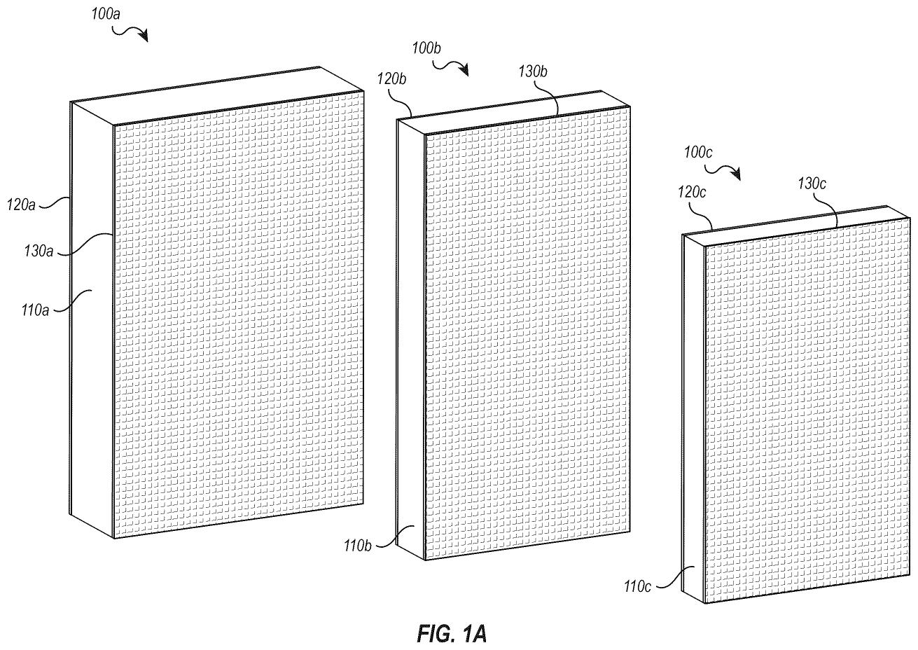

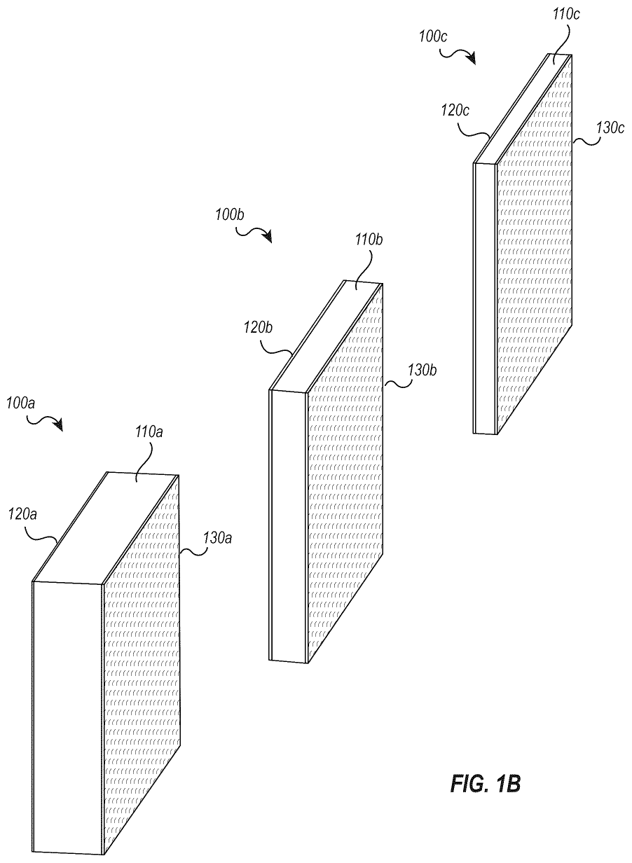

FIGS. 1A and 1B illustrate examples of core composite panel structures 100a, 100b, 100c of varying cross-sectional thickness that can be modified by incorporating a drainage layer to yield lightweight composite building panels of the disclosure. FIGS. 1A and 1B show the layered structure of core composite panel structures 100a, 100b, 100c, including strong, lightweight, and moisture-resistant extruded polystyrene (XPS) foam cores 110a, 110b, 110c sandwiched between first fiber mesh reinforced cementitious layers 120a, 120b, 120c and second fiber mesh reinforced cementitious layers 130a, 130b, 130c. As discussed below, in other embodiments the foam core may comprise other polymer or inorganic foam materials, and one or both protective layers may comprise a thermoset polymer or other rigid protective material.

The cross-sectional thickness of the core composite panel structures 100a, 100b, 100c can be selected based on a combination of desired properties for their intended use to make lightweight building panels having a drainage layer, such as strength, moisture resistance, moisture removal, insulation, spacing between wall elements, and the like. As illustrated in FIGS. 1A and 1B, the cross-sectional thicknesses of the core composite panel structures 100a, 100b, 100c varies mostly or entirely depending on the cross-sectional thickness of the foam cores 110a, 110b, 110c. Although not shown, when core composite panel structures 100 of greater cross-sectional thickness are desired, it may be desirable to increase the thickness of the fiber mesh reinforced cementitious layers 120, 130 (e.g., to account for possible strength reduction caused by including a foam core 110 of greater cross sectional thickness).

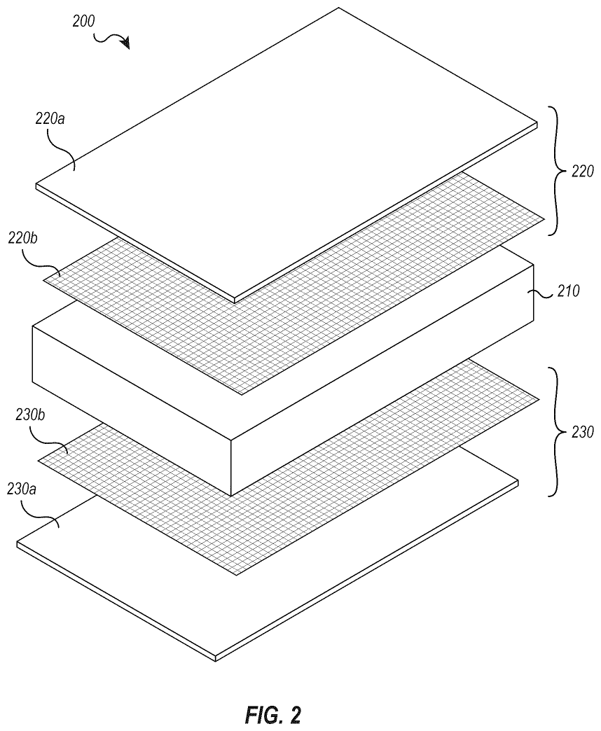

FIG. 2 is in an exploded view that schematically illustrates the layered structure of a core composite panel structure 200, which is similar or identical to the core composite panel structures 100a, 100b, 100c of FIGS. 1A and 1B. The foam core 210 can be a lightweight polymer foam made from closed cell extruded polystyrene (XPS), is lightweight, rigid, waterproof, thermally insulating, and includes two outer surfaces or faces. In some embodiments, the foam core 210 may have a density of about 30-45 kg/m³ and a compressive strength of about 250-400 kPa.

Alternatively, the foam core 110, 210 can be made from a different polymer foam material, such as, but not limited to, expanded polystyrene foam (EPS), polyisocyanurate foam, polyurethane (PUR) foam, phenolic polymer (e.g., phenol-formaldehyde) foam, melamine polymer (e.g., melamine-formaldehyde) foam, and/or other thermoplastic or thermoset polymer known in the art that can be formed into rigid or semi-rigid foam layers. An advantage of thermoset polymer foam materials is they are generally more fire- and heat-resistant than thermoplastic polymers, with thermoset phenolic polymers in particular providing a high level of fire and heat resistance.

The properties of various polymers that can be used to make foam core layers 110, 210 are set forth in Tables 1-3.

TABLE 1

| Property | XPS/EPS | Phenolic | |
|---|---|---|---|
| Material Type | Thermoplastic | Thermoset (phenol- | |
| | polystyrene | formaldehyde) | |
| Thermal Conductivity (W/m · K) | 0.028-0.033 | 0.018-0.022 | |
| R-Value per inch | ~5.0 | 6.5-7.2 | |
| Fire Resistance | Poor - melts, drips | Excellent - chars, low | |
| | | smoke | |
| Flame Spread (ASTM E84) (W/O Facer | 75-200 | <25 (Class A) | |
| Smoke Development (W/O Facer) | >450 (often) | <50 | |
| Thermal Stability | ~93° C. (melts) | 150-175° | C. |
| Water Resistance | Excellent | Good (closed-cell) | |
| Compressive Strength | 200-300 kPa | 100-150 | kPa |

| | | |
|---|---|---|
| Flexural Strength | Flexible, good | Brittle |
| Recyclability | Yes (thermoplastic) | No |
| Weight (kg/m³) | 25-35 | 35-50 |
| Cost | Low-Moderate | High |

TABLE 2

| Property | Melamine | PUR | |
|---|---|---|---|
| Material Type | Thermoset (melamine- | Thermoset (polyol + | |
| | formaldehyde) | isocyanate) | |
| Thermal Conductivity (W/m · K) | 0.032-0.036 | 0.020-0.025 | |
| R-Value per inch | ~4.1-4.5 | ~6.0-6.5 | |
| Fire Resistance | Excellent - non- | Poor - needs FR | |
| | melting, self- | additives | |
| | extinguishing | | |
| Flame Spread (ASTM E84) (W/O Facer | <25 (Class A) | Varies (often >25) | |
| Smoke Development (W/O Facer) | Very low | High | |
| Thermal Stability | ~240° C. | ~100-120° | C. |
| Water Resistance | Poor unless sealed | Good | |
| Compressive Strength | Low | 150-300 | kPa |

| | | |
|---|---|---|
| Flexural Strength | Very brittle | Strong |
| Recyclability | Limited | No |
| Weight (kg/m³) | 7-12 | 30-45 |
| Cost | High | Moderate |

TABLE 3

| Property | Polyiso | |
|---|---|---|
| Material Type | Thermoset (polyisocyanurate) | |
| Thermal Conductivity (W/m · K) | 0.020-0.023 | |
| R-Value per inch | ~6.0-6.5 | |
| Fire Resistance | Good - chars, often Class A | |
| | with facer | |
| Flame Spread (ASTM E84) (W/O Facer | <25 (Class A with facer) | |
| Smoke Development (W/O Facer) | <150 | |
| Thermal Stability | ~150° | C. |
| Water Resistance | Fair (can degrade if | |
| | unprotected) | |
| Compressive Strength | 140-200 | kPa |

| | |
|---|---|
| Flexural Strength | Moderate |
| Recyclability | Rarely recycled |
| Weight (kg/m³) | 30-42 |
| Cost | Moderate-High |

With reference to FIG. 2, formed over first and second outer surfaces of the foam core 210 are first and second layers of fiber (e.g., fiberglass) mesh 220b, 230b, respectively, which become embedded within respective first and second layers of fresh cementitious composition applied over the fiber mesh layers 220b, 230b, which harden or cure to form first and second cementitious layers 220a, 230a. Together, the hardened cementitious layers 220a, 230a and embedded fiberglass mesh layers 220b, 230b form first and second fiber mesh reinforced cementitious layers 220, 230, which adhere to the foam core 210 to form a strong but lightweight core composite panel structure. The fiber mesh layers 220b, 230b can alternatively include other fibers or filaments, such as carbon fibers or filaments.

The lightweight foam core is typically made from extruded polystyrene foam (XPS), but can alternately comprise expanded polystyrene foam (EPS), polyisocyanurate foam, polyurethane (PUR) foam, phenolic polymer (e.g., phenol-formaldehyde) foam, melamine polymer (e.g., melamine-formaldehyde) foam, and/or other thermoplastic or thermoset polymer known in the art that can be formed into rigid or semi-rigid foam layers. The lightweight foam core can be made of closed cell polystyrene foam to provide a water-resistant barrier (e.g., 100% waterproof).

Alternatively, the foam core may comprise an inorganic foam, such as a refractory foam material, to provide additional fire-resistance. Examples include silica gel, aerogel, silicate foams, urea-silicate foam, SiOC/SiC, ceramic foams, refractory foams, and the like. The inorganic foam core can resist melting even when exposed to fire or intense heat in order for the core composite panel structure to maintain its structural integrity.

In some embodiments, the core composite panel structures are manufactured by applying a fiber (e.g., fiberglass) mesh and fresh cementitious composition onto first and second surfaces of a rigid polymer (e.g., XPS) or inorganic foam core and causing or allowing the applied cementitious composition to harden. The fiber mesh becomes embedded in the hardened cementitious layer to enhance strength, increase toughness, and prevent cracking of the hardened cementitious layer. Alternatively, at least one of the hardened cementitious layers can be replaced or augmented with a cured polymer layer.

The layers of fiber mesh reinforced cementitious composition are generally “thin” (e.g., typically less than about 3 mm, less than about 2.5 mm, less than about 2 mm, or less than about 1.5 mm, such as about 1 mm, or between about 0.5-3 mm, about 0.75-2.5 mm, about 1-2 mm, or about 1.25-1.75 mm in cross-sectional thickness). The fiber mesh reinforced cementitious layers can be very lightweight yet waterproof and have high structural strength (i.e., high tensile and flexural strength and high toughness). The fiber mesh component is typically fiberglass fiber or glass filament mesh, but can be made of other strong fibers or filaments, such as carbon fibers or filaments. In some embodiments, fiberglass mesh is formed of an alkali-resistant material and may have nominal mesh size of 4×4 mm with a strand diameter of about 0.5-1.0 mm.

In some embodiments, the fresh cementitious composition comprises mixture products of water, hydraulic cement, silicon dioxide powder, calcium oxide, iron oxide, plaster of Paris (gypsum hemihydrate), water-reducing agent, defoamer, styrene, and acrylic acid. The fresh cementitious composition may optionally include supplementary cementitious materials (SCMs), such as ground granulated blast furnace slag (GGBFS), fly ash, natural pozzolan, silica fume, microsilica, metakaoline, ground glass, calcined clay, finely ground quartz, limestone powder, and the like. The cementitious composition may include other components, such as natural hydraulic lime, calcium silicate, and/or expanded glass, which can increase fire and heat resistance.

In a more particular embodiment, the cementitious composition applied to the outer surfaces of the foam core to form fiber mesh reinforced cementitious layers of the core composite panel structures can be formed by mixing together the following components (expressed in weight percent) to form a fresh flowable cementitious composition, which is applied to the foam core surfaces, together with fiber mesh, and then allowed to harden or cure:

| | |
|---|---|
| Hydraulic cement | 30-50% |
| Silicon dioxide | 40-60% |
| Calcium oxide | 2-5% |
| Iron oxide | 0.2-1% |
| Gypsum hemihydrate | 3-8% |
| Water-reducing agent | 0.2-0.6% |
| Defoamer | 0.2-0.6% |
| Styrene | 1-2% |
| Acrylic acid | 1-2% |
| Water | (16-20%, preferably 18.4% of |
| | dry ingredients above) |

The hydraulic cement typically includes Portland cement clinker interground with gypsum for set control, but may also include other interground minerals, such as limestone filler (e.g., 5-10% by weight of the hydraulic cement), and optionally one or more supplementary cementitious materials (SCMs), such as ground granulated blast furnace slag (GGBFS), fly ash, natural pozzolan, silica fume, microsilica, metakaoline, ground glass, calcined clay, finely ground quartz, and the like. The silicon dioxide can be 150 mesh ground quartz sand. The water reducer can be a low-range water reducer, such as a compound of carboxylic acid grafted multi-polymer and other effective additives. The defoamer can reduce the surface tension of water, solution, suspension, etc., prevent the formation of foam, or reduce or eliminate the original foam. The main component of the defoamer can be polydimethylsiloxane (Me₃SiO(Me₂SiO)nSiMe₃)(Me=methyl). In the case where very fine SCMs (e.g., silica fume, microsilica, or metakaoline), it may be desirable to use a high range water reducer (e.g., polycarboxylate ether) to obtain good flow. The styrene and acrylic acid components, which may be a copolymer, can form a chemical bond to the extruded polystyrene foam core, in addition to the physical bond.

The components of the cementitious composition can be mixed by high-performance mixing equipment through precise batching, and then fed into a mixing barrel in sequence for high-speed dispersion and mixing, thus yielding a fresh cementitious mixture. The fresh cementitious mixture is blended in a tank to make it into liquid or plastic form. The liquid cementitious mixture is then pumped into a machine variously called a “waterfall machine,” commonly known as a “curtain coater” or enrobing “coater/machine”, which has flow control of the liquid cementitious mixture and which will apply the liquid cementitious mixture onto surfaces of an extruded polystyrene foam sheet or other material to be coated. The liquid cementitious mixture is applied like a waterfall or curtain through a blade applicator to evenly apply it to the polymer foam surfaces or other surface to be coated. The product is then cured and left to stand for approximately 7 days as usual practice. However, if ambient conditions are dry and hot, the curing period could be shortened to approximately 3-4 days.

In general, the hardened fiber mesh reinforced cementitious composition can adhere and bond strongly to the polymer or inorganic foam core to form a strong core composite panel structure that does not delaminate. The bond between the cementitious layers and the foam layer is likely a combination of physical and chemical interactions. When applied to the polymer or inorganic foam layer, the liquid cementitious composition can penetrate into surface pores of the foam layer, which upon hardening of the cementitious composition, forms a strong mechanical bond. This bond can be further enhanced through the inclusion of very fine pozzolans, such as silica fume, microsilica, or metakaoline on the cementitious composition, which creates a very high strength cementitious layer and are able to fill very small micropores. The polymer components of the cementitious composition may also interact with components of the foam layer to form a type of chemical bond between the cementitious layers and the foam (e.g., polymer) layer. Regardless of how bonding occurs, it is demonstrably very strong and does not delaminate during specified use. Curable resins also adhere and bond strongly to the foam core.

In some embodiments, when manufacturing the core composite panel structure, the fiberglass mesh is first laid down on a polymer (e.g., extruded polystyrene) or inorganic foam sheet. A transportation belt then transports the foam sheet with the fiberglass mesh through the waterfall machine (commonly known as a “curtain coater” or enrobing “coater/machine”), which causes the liquid cementitious mixture to flow down like a waterfall or curtain, with control of the liquid cementitious mixture flow, onto the foam sheet or other substrate. In this way, the fiberglass mesh becomes embedded in the liquid cementitious mixture and essentially floats in the middle of the cementitious mixture. In other words, a portion of the liquid cementitious mixture will be positioned between the fiberglass mesh and the foam sheet in order to directly adhere to the foam sheet, and another portion of the liquid cementitious mixture will cover and encapsulate the fiber mesh to form the top surface of the core composite tile structure. The result is a layered composite core structure, with an interior polymer or inorganic foam sheet, an underlying layer of cementitious composition in direct contact with the foam sheet, a fiberglass mesh in the middle, and a top layer of cementitious composition covering the fiberglass mesh.

In addition to, or instead of, a fiber mesh reinforced cementitious layer, one or both protective layers of the composite core panel structure may comprise other materials in addition to or instead of the cementitious composition. Examples include one or more of rigid magnesium oxide material, water-resistant polymer, or a composite material comprising a resin or polymer with embedded fibers, fiber mesh, fabric, scrim, felt, or non-woven. The material forming the fibers, fiber mesh, fabric, scrim, felt, or non-woven can be selected from plant fibers, polymer fibers, and inorganic fibers (e.g., basalt, rock wool, and the like). The resin or polymer may comprise a thermoplastic or thermoset material, such as UV-cured resins, polypropylene, polycarbonate, polyethylene terephthalate, polystyrene, acrylate, methacrylate, polyurea, polyaspartic, or epoxy. Protective layers of thermoset polymer can be slightly thicker than fiber mesh reinforced cementitious layers, such as between about 1-5 mm or about 2-3 mm.

Polyurea is a type of elastomer that is derived from the reaction product of an isocyanate component and an amine component. The isocyanate can be aromatic or aliphatic in nature. It can be monomer, polymer, or any variant reaction of isocyanates, quasi-prepolymer or a prepolymer. The prepolymer, or quasi-prepolymer, can be made of an amine-terminated polymer resin, or a hydroxyl-terminated polymer resin. The resin blend can include amine-terminated polymer resins and/or amine-terminated chain extenders. The resin blend may also contain additives or non-primary components, such as pigments pre-dispersed in a polyol carrier. Normally, the resin blend does not contain a catalyst. This is because the reaction between an isocyanate and amine is extremely fast and hence does not need catalysis.

The chemical structure of polyurea is as follows:

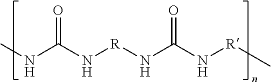

In a polyurea, alternating monomer units of isocyanates and amines react with each other to form urea linkages, as shown below.

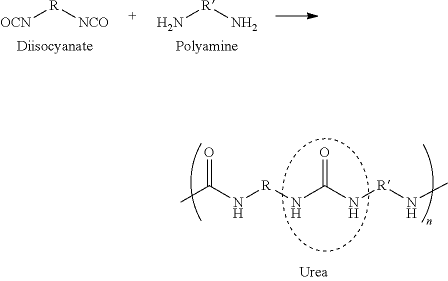

Polyaspartic resin is a solvent-free, aliphatic amine coating material based on aspartic acid, polyaspartic acid, or polyaspartic ester, which reacts with an isocyanate to create extremely durable protective coatings with rapid cure times, excellent abrasion resistance. An example of a curable polyaspartic resin has the following reactants and final cured polymer structure:

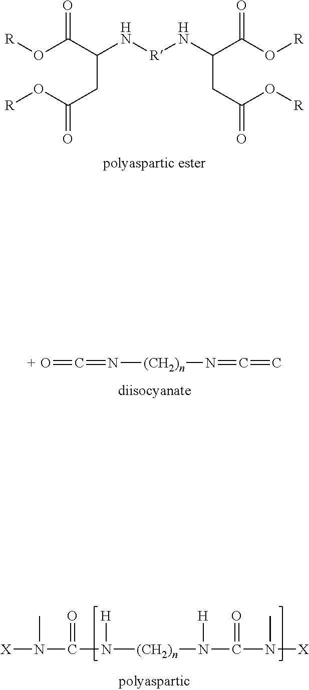

The curable resin can be applied by spray coating while in a flowable state to one or both surfaces of the foam core and allowing it to cure and form a solid protective layer. Multiple parts of the curable resin can be mixed just prior to entering or within the nozzle used to spray coat the foam core. Where it is desired to incorporate a fiberglass mesh sheet in the polymer layer, an initial coating of curable resin can be applied to the foam core, followed by applying the fiberglass mesh sheet over the resin, followed by applying a final coating of the curable resin.

In some embodiments, the outlines of the fiberglass mesh embedded within the hardened cementitious or cured resin layer can be visible and form a grid-like texture that improves adhesion of structural and/or decorative materials thereto, such as cementitious coatings, adhesives, stucco, paint, thin bricks, stones, shingles, clay tiles, and the like. For example, one or more stucco layers can directly adhere to the fiber mesh reinforced cementitious layer without the need for wire mesh, scratch coat, and brown coat used in conventional stucco systems. Nevertheless, it may be desirable to apply a layer of thin set mortar to cover screws, sealants, holes, or other discontinuities in the lightweight composite panels prior to applying a finished stucco layer (which can be cementitious or acrylic based).

Additional information and features relating to lightweight composite panels and their uses in making various building products are disclosed in U.S. Prov. App. No. 63/686,489, filed Aug. 23, 2024; U.S. Prov. App. No. 63/692,563, filed Sep. 9, 2024; U.S. Prov. App. No. 63/703,834, filed Oct. 4, 2024; U.S. Prov. App. No. 63/720,649, filed Nov. 14, 2024; U.S. Prov. App. No. 63/729,637, filed Dec. 9, 2024; U.S. Prov. App. No. 63/744,115, filed Jan. 10, 2025; U.S. Prov. App. No. 63/747,543, filed Jan. 1, 2025; U.S. Prov. App. No. 63/753,600, filed Feb. 4, 2025; U.S. Prov. App. No. 63/764,354, filed Feb. 27, 2025; U.S. Prov. App. No. 63/788,276, filed Apr. 14, 2025; U.S. Prov. App. No. 63/849,709, filed Jul. 23, 2025, U.S. Prov. App. No. 63/855,715, filed Aug. 1, 2025, U.S. Prov. App. No. 63/857,807, filed Aug. 5, 2025, and U.S. Prov. App. No. 63/862,235, filed Aug. 12, 2025. The foregoing applications are incorporated by reference in their entirety.

### III. Lightweight Composite Building Panels With Incorporated Drainage Layer

In order for lightweight composite building panels to facilitate removal of moisture between the panels and underlying sheathing or other structural elements, such as where the panels are used as underlayment or backer board to applied a desired exterior finish of a building, the core composite panel structures described herein are modified to incorporate a drainage layer that faces wall sheathing or other underlying structural elements. The drainage layer is typically a made from a polymer material and includes passages and gaps that facilitate removal of moisture, such as diffusion of water vapor and/or drainage of liquid water.

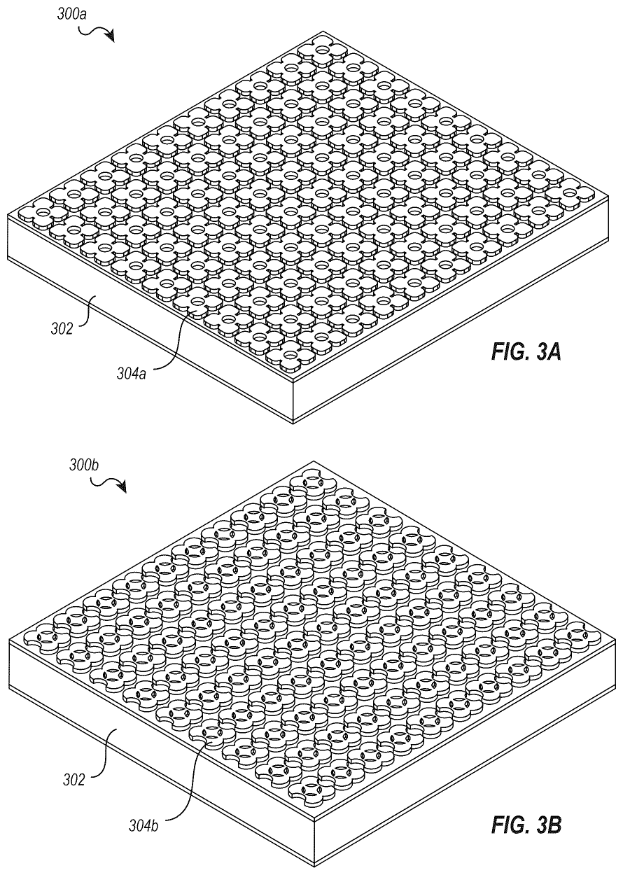

FIGS. 3A and 3B illustrate lightweight composite building panels 300a, 300b for exterior use that includes a core composite panel structure 302 and incorporated drainage layers 304a, 304b made of polymer or other material that provides a pathway for removal of moisture from between the lightweight composite building panels 300a, 300b and sheathing or other structural elements of an exterior wall or roof structure (not shown). The drainage layer 304a, 304b can be called or referred to as an uncoupling membrane, drainage plane, rain screen, dimple board, or bleed layer. For purposes of this disclosure, they are collectively referred to as a “drainage layer”. The drainage layers 304a, 304b include physical gaps to promote drainage and removal of moisture that might otherwise collect between the lightweight composite building panels 300a, 300b and the underlying wall or roof structure to which they are attached.

The drainage layers 304a, 304b can be attached to a surface of the core composite panel structures 302a, 302b using adhesives known in the art. In some embodiments, the drainage layers 304a, 304b can be adhered to the core composite panel structures 302a, 302b using a standard polymer modified mortar, such as the cementitious composition used to form the outer surface layers of the core composite panel structures 302a, 302b. In some embodiments, the protective layer on the side of the core composite panel structure 302 that is configured to be placed against sheathing or other structural elements may comprise a waterproof (e.g., polymer) material that is pre-formed or molded to include gaps and channels that can function as a drainage layer to facilitate moisture removal.

The surface of the lightweight composite building panels 300a, 300b opposite the drainage layers 304a, 304b can be a fiber mesh reinforced cementitious layer that can be used to apply a desired exterior surface finish, such as stucco, thin bricks, tiles, stone veneers, shingles, and the like. The lightweight composite building panels 300a, 300b provide a waterproof exterior surface that also provides for moisture removal, such as to prevent growth of mold and mildew or structural damage to the underlying wall or roof structure.

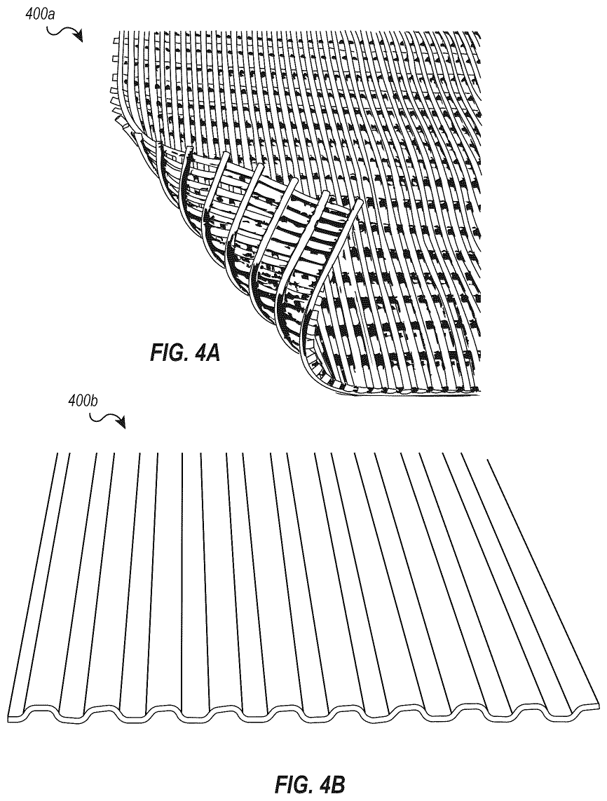

FIGS. 4A-4D illustrate alternative embodiments of drainage layers 400a, 400b, 400c, 400d, 400e that provide gaps or channels and that can be adhered or attached to the interior side of a core composite panel structure to create a lightweight composite building panels to which an exterior surface finish, such as stucco, thin bricks, tiles, stone veneers, shingles, wood shakes, metal cladding, and like can be attached. The drainage layers 400a, 400b, 400c, 400d, 400e are not required to bear structural loads because the lightweight composite building panels, having the strong core composite panel structure described herein, can be screwed, nailed, glued, or otherwise secured to the underlying wall or roof structure so as to bear the entire load, including loads from applied exterior finishes, such as stucco, thin brick, stone, tiles, and the like. The only function of the drainage layers 400a, 400b, 400c, 400d, 400e is to provide gaps that facilitate removal of moisture from between an outer wall of a building and lightweight composite panels.

The drainage layer can alternatively comprise factory-applied dimples to the back side of a lightweight composite building panel. A built-in drainage plane can be made by applying a field of raised adhesive dimples to the back surface of each lightweight composite building panel. These spaced contact points create a capillary break, enabling vertical drainage of incidental moisture. This method eliminates the need for separately installed rainscreen mats or drainage layers (either in the field or in the factory) while maintaining full panel-sheathing contact.

In a controlled factory setting, automated metered dispensers are configured to apply a substantially uniform grid of polymer-based dots or beads to the panel back. Each bead can be cured to a consistent height of about 1/16 inch to ¼ inch, maintaining an air gap between the panel and substrate. An illustrations of a recommended configuration for the applied dots or dimples are as follows:
Dot height: 1.5-6 mm ( 1/16 inch to ¼ inch);
Spacing: 2 inches to 4 inches on center. Even spacing allows for horizontal or vertical panel installation in the field;
Coverage: full panel back except edges within 2 inches of perimeter

Example materials that can be used to form the dots or dimples can have the following characteristics:
Preferred: 1 k or 2 k polyurethane (moisture or chemically cured);
Alternatives: high-density silicone (RTV) or hot-melt adhesives (if appropriate for temperature range);
Adhesive should exhibit adequate bond panel surface, maintain shape under load, and resist water, freeze/thaw, and thermal cycling.

The following are example performance goals for drainages layers generally, and applied dots or dimples specifically:
Maintain continuous drainage channel per ASTM E2273 principles;
Sustain compression resistance under fastener tension and cladding load;
Support full panel structural and moisture management performance without compromising finish integrity.

The lightweight composite building panels are typically rectangular in shape, with a constant cross sectional thickness. The lightweight composite building panels can have multiple uses, including for interior walls that are exposed to moisture, providing a substrate to which tiles, stones, or other surface treatments can be applied, other interior walls (e.g., plaster coated composite panels), exterior paneling that covers and/or replaces OSB panels, as a substrate for stucco, thin brick, natural or manufactured stone, or other finishes, roofing boards that function as underlayment for shingles, roofing tiles, metal roofing sheets, wood shakes, and the like, floor underlayment, ceiling panels, and shaft liners.

### IV. Example Uses of Lightweight Composite Building Panels With Incorporated Drainage Layer

The lightweight composite building panels can be used in place of conventional wallboards, panels, sheathing, and cladding, including for a variety of uses such as interior drywall, backer boards for tile and other interior finishes, including those exposed to moisture, exterior wall sheathing and finishes applied thereto, floor underlayment, soffits, roofing decks and roof elements applied thereto, shaft liners, and the like.

The lightweight composite building panels can be cut, drilled, and fastened to structural elements of buildings, such as wall frames comprising wooden or metal studs, roof frames comprising boards, studs, or trusses, floor joists, concrete floors, foundations, and the like. Because both sides of the core composite panel structure comprise a fiber mesh reinforced cementitious composition, the lightweight composite building panels are strong and can support relatively heavy loads, such as thin bricks, wall tiles, stone veneers, stucco, roofing tiles, shingles, metal cladding, wood shakes, and other finishes applied thereto and/or fixtures or other items using nails, screws, adhesives, and other fasteners known in the art.

In some embodiments, lightweight composite building panels can be used as backing for exterior finishes, such as stucco, thin bricks, stone veneers, or other finishes. For this reason, the lightweight composite building panels, including for application of a surface finish, include a drainage layer, such as an uncoupling membrane, drainage plane, rain screen, dimple board, factory-applied dimples or dots, or bleed layer, which provides gaps and channels between the lightweight composite panels and the underlying building surface to permit moisture (e.g., from ingress or condensation) to collect, drain and/or evaporate, thereby protecting the outer surface finish, preventing formation of mold and mildew, and preventing structural damage to the underlying building wall and exterior surface finish.

The lightweight composite panels can be fastened to wall or roof structures of a building using mechanical fasteners and adhesives known in the art, such as wood screws, sheet metal screws, nails, rivets, and construction adhesive. Mechanical fasteners are advantageously corrosion resistant. Strips of tape can be used as a template to ensure proper placement of screws or other mechanical fasteners when fastening lightweight composite panels to studs or other structural elements of wall or roof structures.

In some embodiments, the lightweight composite building panels can be used as an intermediate layer between exterior sheathing (e.g., OSB panels) and an applied finish, such as stucco, thin bricks, stone veneers, tiles, shingles, cladding, and the like. The drainage layer facilitates removal of moisture between the lightweight composite building panels and sheathing or other underlying structural elements of an exterior wall or roof structure.

In general, all drained enclosure systems, whether walls, basements, or roofs, are typically required to have a screen or cladding, a drainage gap (often a clear air space), a drainage plane (a water repellent plane), flashing at the base to direct water outwards, and drain holes (weep holes) to allow water out of the drainage gap. Water flows down under the force of gravity clinging to a surface, e.g., the interface between the back of the cladding and the airspace or the interface between roofing paper and a roof shingle. It has been shown that water can drain through very small gaps (e.g., 1-2 mm), even the small gap between two sheets of building paper.

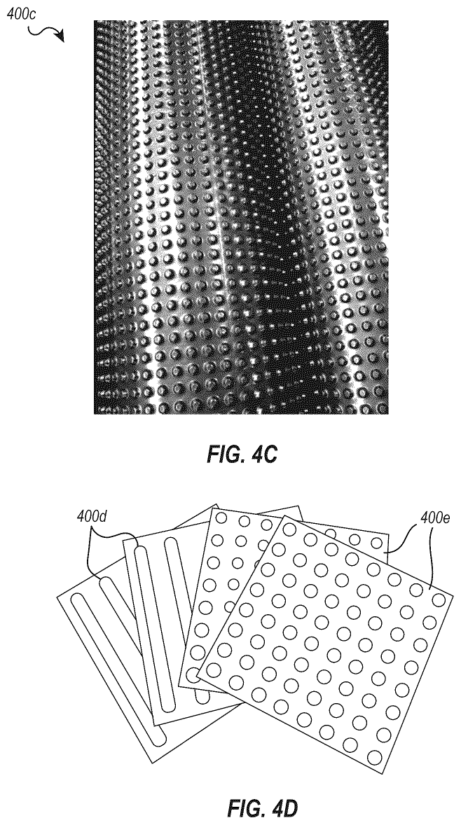

Reference is made to FIGS. 5A-5C, which illustrate exterior building elements or finishes 500 attached to an underlying wall 502 of a building. They illustrate how a gap 504 is provided between the exterior building elements or finishes 500 and the underlying building wall 502. This gap 504 permits moisture that may have entered this region to be drained and/or evaporated away from the underlying building wall 502. FIG. 5A in particular illustrates how condensed liquid water 506 can drain from the bottom of the gap 504 and how water vapor 508 can vent from the top of the gap 504. FIG. 5B illustrates how water that may penetrate through an exterior finish 700 can drain though the gap 504. FIG. 5C illustrates how water that may penetrate through an exterior finish 500 can drain though the gap 504 and/or how water vapor can diffuse through the exterior finish 500.

The lightweight composite building panels can be attached to wall or roof structures, including sheathing and other structural elements using known attachment means, including screws, nails, and adhesives. To prevent screws from tearing through the exterior fiber mesh reinforced cementitious layer, screws can be used with enlarged washers having high surface area to distribute the pressure or load over a high surface area of the lightweight composite panels. Specialized washers with penetrating prongs can be used (e.g., with screws) to limit rotation and penetration, preventing damage to the lightweight composite panels. Rectangular washers with multiple prongs on either side of the screw can be used to tie adjacent lightweight composite panels together. The penetrating prongs can have a length so that the washers lie flush with or just below the surface of the exterior fiber mesh reinforced cementitious layer. A patch coating can be applied over the washers to fill any indentations caused by the washers or other mechanical fasteners.

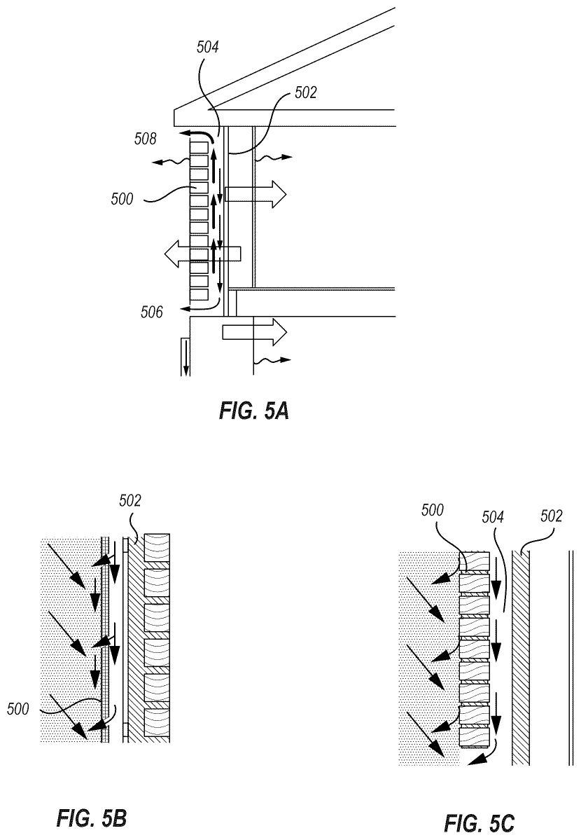

FIGS. 6A-6C illustrate a fastener assembly 600 comprising a screw 602 and specialized washer 604 with enlarged surface area and penetrating prongs 610 for attaching a lightweight composite building panel 620 to a stud 628 or other structural element (e.g., OSB sheathing). The penetrating prongs 610 help fix the washer 604 in place relative to the lightweight composite building panel 620 prevent rotation of the washer 604 when the screw 602 is being driven into the stud 628 or other structural element of a wall or roof structure and add additional lateral strength between the washers 604 and the lightweight composite building panel 620. The penetrating prongs 610 can also be designed to abut the underlying stud 628 or other structural element and act as a stop to prevent the washer 604 from being driven too far into the lightweight composite building panel 620 and undesirably crushing or fracturing the exterior fiber mesh reinforced cementitious (or other protective) layer 622, which could reduce the strength of an exterior wall structure or roofing deck.

FIG. 6A more particularly illustrates the use of a specialized fastener assembly 600 comprising a screw 602 and specialized washer 604 having a body 606 of enlarged diameter, a concave interior portion 608, and a plurality of penetrating prongs 610 extending laterally from the washer body 606. Although the specialized washer 604 in this embodiment is illustrated as having a circular washer body 606, other embodiments of specialized washers may include enlarged rectangular-shaped washer bodies (not shown) designed to more completely overlap and adjoin adjacent lightweight composite panels during installation.

The penetrating prongs 610 are designed to penetrate through and become embedded within a lightweight composite building panel 620, including though the exterior fiber mesh reinforced layer 622, at least partially through the foam core 624, and optionally through the interior fiber mesh reinforced layer 626 and drainage layer (not shown) so as to make abutment with a stud 628 or other structural element (e.g., OSB sheathing) of a wall or roof frame. The penetrating prongs 610 help retain the specialized washers 604 in a desired position relative to the lightweight composite panel 620 and prevent rotation while the screw 602 is being driven through the lightweight composite panel 620 and into the underlying stud 628 or other structural element (e.g., OSB sheathing) of a wall or roof structure. The penetrating prongs 610 can also provide a load spreading/pressure spreading effect to distribute normal and lateral pressure from the screw 602 and washer body 606 to the prongs 610. The specialized washer 604 and penetrating prongs 610 provide greater lateral tension of the screw and washer assembly relative to the lightweight composite building panel 620, thereby increasing the overall shear strength of a wall or roof structure.

FIG. 6B is a bottom perspective view and FIG. 6C is a top perspective view of the specialized washer 604, which more particularly illustrate features of the specialized washer 604. The washer body 606 can have an enlarged diameter in order to provide higher surface area and increase contact between the specialized washer 604 and an adjacent fiber reinforced cementitious (or other protective) layer of a lightweight composite building panel. The washer body 606 can have a concave interior portion 608, which permits an outer rim 612 to become substantially flush with, and the concave interior portion 608 to advance below, the adjacent fiber reinforced cementitious (or other protective) layer when used to attach a lightweight composite building panel to a wall or roof structure (as shown in FIG. 6A). This allows the concave interior portion 608 to partially compress the interior foam core 624 and exterior fiber reinforced cementitious (or other protective) layer 622 of the lightweight composite building panel to provide firm and reliable attachment of the panel to the wall or roof structure. The washer body 606 can include a countersink 614 that accommodates the head 603 of the screw 602 so that the screw head 603 does not protrude beyond the surface of the washer body 606 when driven into a stud 628 or other structural element of a wall or roof frame.

The length of the penetrating prongs 610 can be selected to determine and limit how far the concave interior portion 608 of the washer body 606 is able to advance into and compress the lightweight composite building panel 620, forming a depression therein. The penetrating prongs 610 can advantageously have a length in order to penetrate all the way through the lightweight composite building panel 620 and make contact with the stud 628 or other structural element (e.g., OSB sheathing). In this way the penetrating prongs 610 can act as a stop that limits how far the specialized washer 604 can be driven toward and into the lightweight composite building panel 620. Providing a stop prevents the specialized washer 604 from being driven too far into the lightweight composite building panel 620, thereby preserving the structural integrity and strength of the exterior fiber mesh reinforced cementitious (or other protective) layer 622 adjacent to the specialized washer 604. This preserves and maximizes the overall strength, including shear strength, of the wall structure.

In some embodiments, it may be desirable for the length of the penetrating prongs 610 to be slightly less than the cross-sectional thickness of the lightweight composite building panel 620 in order to superficially compress, but not damage, the exterior fiber mesh reinforced cementitious (or other protective) layer 622 toward the polymer foam core 624 to thereby increase the compressive force of the washer 604 bearing against the lightweight composite building panel 620. This can increase the overall fixation strength of the fastening assembly 600.

In some embodiments, sealing one or more joints or seams between adjacent lightweight composite building panels includes applying waterproof tape, metal flashing, polyurethane foam, fiber mesh tape and an appropriate seam coat (e.g., thin set mortar or fine sanded stucco), or other sealing means known in the over the joints or seams, including joints or seams in the wall or roofing deck face and corners. In addition, joints, seams, openings, or gaps between lightweight composite building panels and other structural elements, such as wooden or metal beams or posts, vent pipes in roofs, fixtures, and the like, can be filled using sealing means known in the art, such as polyurethane foam, metal flashing, or tar.

In some embodiments, an appropriate seam coat can be applied over at least a portion of the exterior facing fiber mesh reinforced cementitious (or other protective) layer, including over any exposed screws, washers, or other mechanical fasteners used to attach the lightweight composite building panels to the exterior wall or roof structure, and over any joints or seams, fiber mesh tape, polyurethane, or other exposed sealants on or in the exterior wall or roof structure.

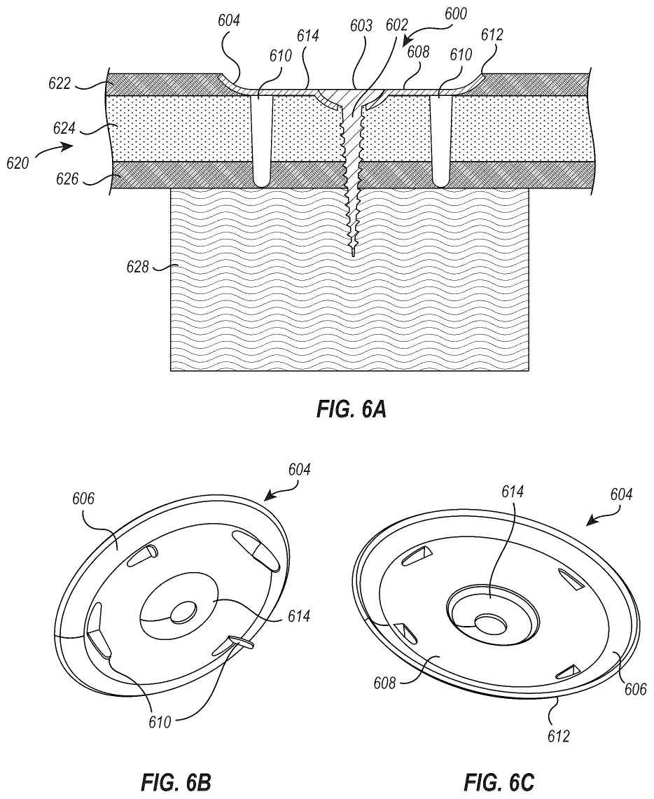

FIG. 7 illustrates an example use of lightweight composite building panels disclosed herein by direct application of a stucco finish. FIG. 7 more particularly illustrates a stucco system 700 that includes a lightweight composite building panel 702, which includes an exterior-facing fiber mesh reinforced cementitious (or other protective) layer as a bonding substrate. The lightweight composite building panel 702 can be fastened to a wall or roof structure (not shown) by means of screws 704. Two of the screws 704 are shown covered by a patch coat 706 (e.g., thin set mortar or fine-sanded stucco) to create a smooth surface. A stucco finish 708 is applied over the fiber mesh reinforced cementitious (or other protective) layer 702 and patch coat 706. Both cement-based stucco and acrylic stucco can readily adhere directly to the fiber mesh reinforced cementitious (or other protective) layer 702 and patch coat 706. A primer is typically not required when using acrylic-based stucco, although a primer can be used if desired. Any primer known in the art for acrylic-based stucco can be used.

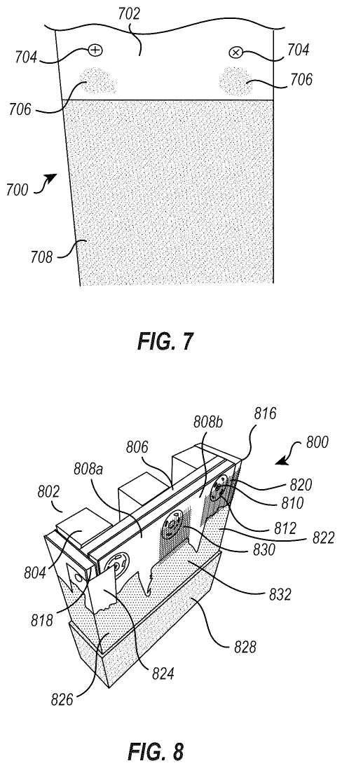

FIG. 8 is a perspective view of a mockup that illustrates the use of lightweight composite building panels to form a backer board or underlayment for direct application of a stucco finish. It will be appreciated that other finishes, such as thin bricks, stone veneers, tiles, shingles, and the like can be attached to the disclosed lightweight composite building panels. FIG. 8 more particularly illustrates another example stucco system 800 according to the disclosure. A difference between this embodiment and that of FIG. 7 is that the embodiment of FIG. 8 utilizes screws 810 pared with enlarged washers 812 to fasten a pair of adjacent lightweight composite building panels 808a, 808b to the exterior wall structure 802, which is formed using studs 804 and OSB sheathing 806.

A vertical concourse of screws 810 and enlarged washers 812 are used to interconnect adjacent lightweight composite building panels 808a, 808b fastened to the OSB sheathing 806. A vertical strip of fiber mesh tape 830 is placed over the vertical concourse of screws 810 and enlarged washers 812 and a portion of the exterior-facing fiber reinforced (or other protective) layers of the adjacent lightweight composite building panels 908a, 908b, followed by applying a vertical strip of an appropriate seam coat (e.g., thin set mortar or fine-sanded stucco) 832 over the fiber mesh tape 830, screws 810 and enlarged washers 812, and a portion of the exterior-facing fiber reinforced (or other protective) layers to further tie the adjacent lightweight composite building panels 808a, 808b together. This further helps prevent separation and potential formation of cracks in the stucco finish 828 at the joint between the adjacent lightweight composite building panels 808a, 808b. The vertical strip of seam coat 832 also forms a more uniform surface to which the stucco finish 828 can be applied.

The example stucco system 800 also includes first and second corners 816, 818 formed between adjacent lightweight composite panels 808 positioned at 90° angles. The first corner 816 is protected by fiber mesh 820 and a first corner layer of an appropriate seam coat (e.g., thin set mortar or fine-sanded stucco) 822 in which the fiber mesh 820 is embedded. The second corner 818 is protected by a rigid corner bend 824, which can be made of galvanized steel or a plastic corner bend with integrated mesh, and a second corner layer of seam coat 826 covering the corner bend 824. It will be understood that the fiber mesh 820 and metal corner bend 824 are alternative embodiments and need not be included in the same embodiment. Rather, some embodiments may use the fiber mesh 820 and other embodiments may use the metal corner bend 824 (e.g., to provide greater protection against mechanical damage caused by blunt force to wall corners). One or more layers of stucco finish 828 (cement- or acrylic-based) is applied over the exterior-facing fiber mesh reinforced cementitious layers, vertical strip of seam coat 832, and first and second corner layers of seam coat 822, 826.

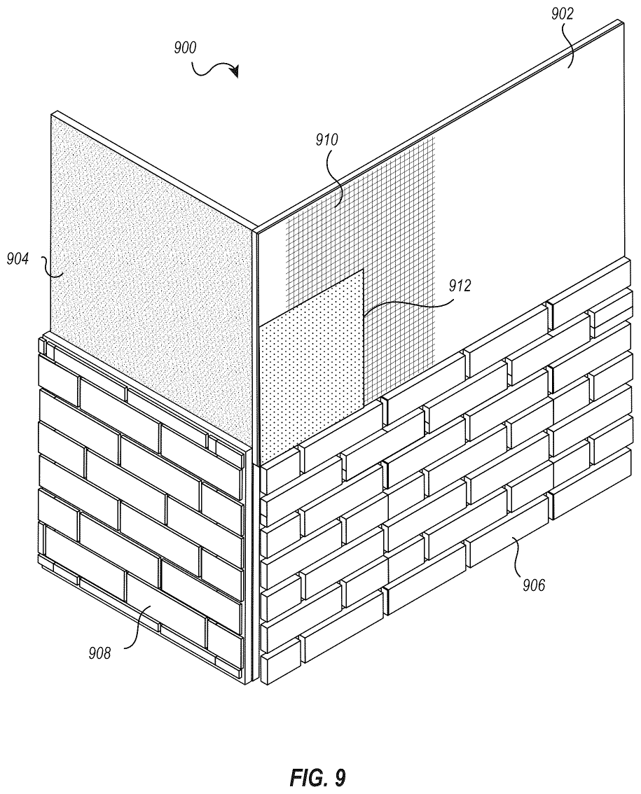

FIG. 9 illustrates an exterior wall 900 that includes lightweight composite building panels 902 attached over an exterior wall structure (not shown) and various exterior finishes applied to the lightweight composite building panels 902. These include a stucco finish 904, stone veneers 906, and tiles 908 applied over different portions of the lightweight composite building panels 902. A layer of fiber mesh 910 and a layer of an appropriate bonding layer 912 (e.g., thin set mortar or fine-sanded stucco) covering the fiber mesh 910 is applied over a portion of lightweight composite building panels 902 to which the various finished are applied. The stucco finish 904 (cement- or acrylic-based) can be applied directly over the bonding layer 912. The stones veneers 1006 can be adhered to the bonding layer 1012 using thin set mortar (not shown) and/or an adhesive. The tiles 908 can be adhered to the bonding layer 912 using thin set mortar (not shown) and/or an adhesive.

Another embodiment of the disclosed lightweight composite building panels is their use as roof sheathing to form a roofing deck to which roofing tiles, shingles, metal cladding, and/or wood shakes can be applied to form a finished roof of a building. The lightweight composite building panels have high strength and rigidity notwithstanding their low density and lightweight owing to the composite structure of the foam layer and the fiber mesh reinforced cementitious (or other protective) layers, which strongly adhere to the foam layer. A roofing system can include roofing joists, trusses to which lightweight composite panels are fixedly attached, such as by constructure adhesive, roofing screws, or roofing nails. The lightweight composite panels are sufficiently strong that they can support the weight of workers standing on top of the roof, as well as the finish roofing elements, when attached to roofing joists, trusses, and joints with typical spacing.

The lightweight composite panels are typically rectangular in shape, with a constant cross sectional thickness. The lightweight composite panel can have multiple uses, including for interior walls that are exposed to moisture, providing a substrate to which tiles, stones, or other surface treatments can be applied, other interior walls (e.g., plaster coated composite panels), exterior sheathing that complements or replaces OSB panels, as a substrate for stucco, thin brick, natural or manufactured stone, or other finishes, roofing boards that function as underlayment for shingles, roofing tiles, metal roofing sheets, wood shakes, and the like, floor underlayment, ceiling panels, and shaft liners. The lightweight composite panels can be modified for specialized uses, such as by applying a decoupling layer, drainage plane, rain screen, dimple board, factory applied dimples, or bleed layer to facilitate removal of moisture between the lightweight composite panels and exterior wall structures.

### Additional Terms & Definitions

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification are to be understood as optionally being modified by the term “about” or its synonyms. When the terms “about,” “approximately,” “substantially,” or the like are used in conjunction with a stated amount, value, or condition in the specification and claims, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

1. A lightweight composite building panel, comprising:
a core composite panel structure comprised of:
a foam core having a first surface and a second surface opposite the first surface;
a first protective layer selected from a first fiber reinforced cementitious layer, first thermoset polymer layer, or first magnesium oxide layer formed over and covering at least a portion of the first surface of the foam core; and
a second protective layer selected from a second fiber reinforced cementitious layer, second thermoset polymer layer, or second magnesium oxide layer formed over and covering at least a portion of the second surface of the foam core; and
a drainage layer incorporated on a side of the core composite panel structure.

2. The lightweight composite building panel of claim 1, wherein at least one of the first or second fiber reinforced cementitious layers is included and comprises fiber reinforcement embedded within a hardened cementitious composition comprising reaction products of a fresh cementitious composition comprising mixture products of water, Portland cement, silicon dioxide, calcium oxide, and gypsum hemihydrate.

3. The lightweight composite building panel of claim 2, wherein the fiber reinforcement is selected from fiber mesh, alkali-resistant fiberglass mesh, embedded fibers, fabric, woven, scrim, felt, and non-woven, wherein the fiber reinforcement comprise at least one of plant fibers, polymer fibers, and inorganic fibers, which are selected from fibers or filaments formed from glass, basalt, rock wool, or carbon.

4. The lightweight composite building panel of claim 2, wherein the fresh cementitious composition comprises mixture products of water, hydraulic cement, silicon dioxide, calcium oxide, iron oxide, gypsum hemihydrate, water-reducing agent, defoamer, styrene, and acrylic acid or polymer thereof, optionally at least one supplementary cementitious material (SCM) selected from the group consisting of ground granulated blast furnace slag (GGBFS), fly ash, natural pozzolan, silica fume, microsilica, metakaoline, ground glass, calcined clay, and finely ground quartz, and optionally at least one of natural hydraulic lime, calcium silicate, or expanded glass.

5. The lightweight composite building panel of claim 2, wherein the fresh cementitious composition comprises mixture products of:

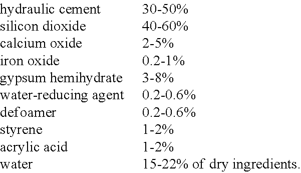

6. The lightweight composite building panel of claim 2, wherein the at least one of the first or second fiber reinforced cementitious layers has a cross-sectional thickness in a range of about 0.5 mm to about 3 mm, or about 0.75 mm to about 2.5 mm, or about 1 mm to about 2 mm, or about 1.25 mm to about 1.75 mm.

7. The lightweight composite building panel of claim 1, wherein at least one of the first or second thermoset polymer layers is included and comprises polyurea or polyaspartic and is optionally fiber-reinforced.

8. The lightweight composite building panel of claim 7, wherein the at least one of the first or second thermoset polymer layers has a cross-sectional thickness in a range of about 1 mm to about 5 mm, or about 2 mm to about 4 mm.

9. The lightweight composite building panel of claim 1, wherein the drainage layer includes a polymer sheet, layer, dots, or dimples, applied, attached, or bonded to the side of the core composite panel structure that is configured to be placed against sheathing or other structural elements.

10. The lightweight composite building panel of claim 9, wherein the drainage layer is selected from an uncoupling membrane, drainage plane, rain screen, dimple board, factory-applied dots or dimples, and bleed layer.

11. The lightweight composite building panel of claim 1, wherein the drainage layer includes or is provided by the first or second protective layer on the side of the core composite structure that is configured to be placed against sheathing or other structural elements and comprises a waterproof (e.g., polymer) material that is pre-formed or molded to include gaps and channels that function as the drainage layer to facilitate moisture removal.

12. The lightweight composite building panel of claim 1, wherein the lightweight composite panel is substantially flat or planar.

13. The lightweight composite building panel of claim 1, wherein the polymer foam core comprises a polymer selected from the group consisting of extruded polystyrene (XPS), expanded polystyrene (EPS), polyisocyanurate, polyurethane (PUR), phenolic polymers (e.g., phenol-formaldehyde), melamine polymers (e.g., melamine-formaldehyde), and other thermoplastic and thermoset polymers that can be formed into a rigid or semi-rigid polymer foam structure.

14. The lightweight composite building panel of claim 1, further comprising a finish on or applied to the first or second protective layer, wherein the finish is selected from the group consisting of thin bricks, wall tiles, stone, stucco, roofing tiles, shingles, metal cladding, wood shakes, and combinations thereof.

15. A lightweight composite building panel, comprising:
a core composite panel structure comprised of:
a polymer foam core having a first surface and a second surface opposite the first surface;
a first protective fiber mesh reinforced cementitious layer formed over and covering at least a portion of the first surface of the polymer foam core; and
a second protective fiber mesh reinforced cementitious layer formed over and covering at least a portion of the second surface of the polymer foam core,
wherein the polymer foam core comprises a polymer selected from the group consisting of extruded polystyrene (XPS), expanded polystyrene (EPS), polyisocyanurate, polyurethane (PUR), phenolic polymers (e.g., phenol-formaldehyde), melamine polymers (e.g., melamine-formaldehyde), and other thermoplastic and thermoset polymers that can be formed into a rigid or semi-rigid polymer foam structure,
wherein each of the first and second protective fiber mesh reinforced cementitious comprises fiberglass mesh embedded within a hardened cementitious composition comprising reaction products of a fresh cementitious composition comprising water, Portland cement, silicon dioxide, calcium oxide, and gypsum hemihydrate; and
a drainage layer incorporated on a side of the core composite panel structure.

16. A lightweight composite building panel, comprising:
a core composite panel structure comprised of:
a polymer foam core having a first surface and a second surface opposite the first surface;
a first protective thermoset polymer layer formed over and covering at least a portion of the first surface of the polymer foam core; and
a second protective thermoset polymer layer formed over and covering at least a portion of the second surface of the polymer foam core,
wherein the polymer foam core comprises a polymer selected from the group consisting of extruded polystyrene (XPS), expanded polystyrene (EPS), polyisocyanurate, polyurethane (PUR), phenolic polymers (e.g., phenol-formaldehyde), melamine polymers (e.g., melamine-formaldehyde), and other thermoplastic and thermoset polymers that can be formed into a rigid or semi-rigid polymer foam structure,
wherein the first and second thermoset polymer layers are independently selected from polyurea and polyaspartic and are optionally fiber-reinforced; and
a drainage layer incorporated on a side of the core composite panel structure.

17. A method of using a lightweight composite building panel as in claim 1, comprising:
providing a wall or roofing structure that includes a wall or roof frame and sheathing attached to the wall or roof frame; and
fastening the lightweight composite building panel to the sheathing so that the drainage layer is positioned between the sheathing and the core composite panel structure.

18. The method of claim 17, wherein the lightweight composite building panel is fastened to the wall or roofing structure using a plurality of fastener assemblies, each fastener assembly comprising a screw and an enlarged washer with multiple prongs that penetrate at least partially through and become embedded within the lightweight composite building panel.

19. The method of claim 18, wherein the enlarged washers of the fastener assemblies compress into the lightweight composite building panel, forming depressions therein, the method further comprising applying a seam coat or bonding layer over the fastener assemblies and filling in the depression to provide a smooth exterior surface.

20. The method of claim 17, further comprising applying an outer surface finish to the lightweight composite building panel, wherein the outer surface finish is selected from stucco, thin bricks, stone veneers, tiles, roofing shingles, wood shakes, and metal cladding.
